(19) United States
(12) Patent Application Publication
(10) Pub. No.: US 2023/0391903 A1
(43) Pub. Date: Dec. 7, 2023

(54) CURABLE COMPOSITION

(71) Applicant: TOAGOSEI CO., LTD., Minato-ku, Tokyo (JP)

(72) Inventors: Kei KONDO, Nagoya-shi, Aichi (JP); Erika ISSHIKI, Nagoya-shi, Aichi (JP); Kenichi ISHIZAKI, Nagoya-shi, Aichi (JP); Eiichi OKAZAKI, Nagoya-shi, Aichi (JP)

(21) Appl. No.: 18/248,948

(22) PCT Filed: Oct. 13, 2021
(86) PCT No.: PCT/JP2021/037953

§ 371 Date: Apr. 13, 2023

(30) Foreign Application Priority Data
Oct. 14, 2020 (JP) 2020-173323

(51) Int. Cl. C08F 122/32; C09J 4/00; C09J 7/38

(52) U.S. Cl. CPC C08F 122/32; C09J 4/00; C09J 7/385; C09J 2301/302; C09J 2433/00

(57) ABSTRACT

A curable composition, including a 2-cyanoacrylate compound represented by Formula (1), in which a storage modulus of a cured product of the curable composition at 23° C. is from 1.0×10⁴ Pa to 1.0×10⁸ Pa and in which, in Formula (1), each L¹ independently represents a linear or branched alkylene group having 2 to 6 carbon atoms which may have a sub stituent, p represents an integer from 2 to 8, and R¹ represents an linear or branched alkyl group, an aryl group, an alkenyl group or an alkynyl group having 1 to 8 carbon atoms which may have a substituent.

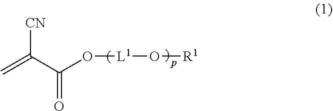

### TECHNICAL FIELD

The present invention relates to a curable composition.

### BACKGROUND ART

Curable compositions containing 2-cyanoacrylate compounds start to polymerize by weak anions such as a slight amount of water adhering to a surface of an adherend due to unique anionic polymerizability of 2-cyanoacrylate compounds, which are the main components, to enable various materials to be strongly bonded with each other in a short time. Therefore, they are used as so-called instant adhesives in a wide range of fields such as industrial, medical and household use.

Cured products of curable compositions containing 2-cyanoacrylate compounds are hard and have excellent shear adhesive strength, but have the drawback of lacking flexibility and having low peeling strength. In addition, the hard cured products of the adhesives do not deform under pressure and do not show pressure sensitive adhesiveness or re-adhesiveness after peeling. Therefore, it is difficult to separate and re-adhere an adherend that has once been adhered, for purposes such as alignment.

Examples of conventional 2-cyanoacrylate compounds or curable compositions containing 2-cyanoacrylate compounds include those described in Patent Documents 1 to 5.

Patent Document 1 describes that a curable composition containing a 2-cyanoacrylate compound having an alkoxyalkyl group as an ester chain can provide a flexible cured product.

Patent Document 2 describes a conformable coating composition that includes a polymerizable cyanoacrylate monomer, an elastomer, and a volatile liquid, in which the cyanoacrylate monomer is from 0.1 to 65% by weight of a non-volatile portion, in which the elastomer in an elastomer phase is at least 35% by weight of the non-volatile portion, and in which the volatile liquid is at least 40% by weight of the total composition.

Patent Document 3 describes a novel 2-cyanoacrylate compound having a halogenated alkoxyalkyloxycarbonyl group as an ester group.

Patent Document 4 describes a flexible cyanoacrylate composition consisting of a 2-cyanoacrylate and dibutyl phthalate.

Patent Document 5 describes a curable composition including: (a) at least one cyanoacrylate monomer selected from a compound of Chemical Formula (I) below,

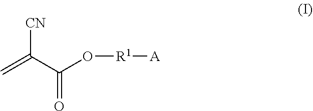

in which, R¹ represents a divalent linking group having 1 to 10 carbon atoms, and A represents a C₅-C₅₀ aryl group or a C₂-C₅₀ heteroaryl group; and (b) at least one (co)polymer.

### PRIOR ART DOCUMENT

### Patent Document

Patent Document 1: Japanese Patent No. S61-13702

Patent Document 2: Japanese National Phase Publication No. 2014-528280

Patent Document 3: Japanese Patent Application Laid-Open No. H08-283225

Patent Document 4: Japanese Patent Application Laid-Open No. H08-48945

Patent Document 5: Japanese National Phase Publication No. 2015-523426

### SUMMARY OF THE INVENTION

### Technical Problem

However, in the invention described in Patent Document 1, although there is a description of flexibility, neither peeling strength test nor evaluation of pressure sensitive adhesiveness was performed.

In addition, Patent Document 2 describes that there is no irritating odor or no whitening phenomenon and describes flexibility of a cured product, but there is no description about peeling strength test or pressure sensitive adhesiveness.

Patent Document 3 describes elongation or durability of a cured product, but there is no description about peeling strength.

Patent Document 4 only describes flexibility and brittleness, but does not describe pressure sensitive adhesiveness.

In the technique described in Patent Document 5, the composition after curing does not exhibit pressure sensitive adhesiveness, and there is no description about peeling strength and re-adhesiveness.

Therefore, the problem to be solved by the present invention is to provide a curable composition of which resulting cured product is excellent in pressure sensitive adhesiveness.

### Solution to Problem

The means for solving the aforementioned problem include the following aspects.

<1> A curable composition, including a 2-cyanoacrylate compound represented by Formula (1) below,

in which a storage modulus of a cured product of the curable composition at 23° C. is from 1.0×10⁴ Pa to 1.0×10⁸ Pa:

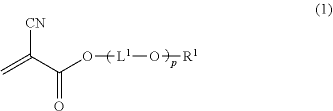

In Formula (1), each L¹ independently represents a linear or branched alkylene group having 2 to 6 carbon atoms which may have a substituent, p represents an integer from 2 to 8, and R¹ represents an linear or branched alkyl group, an aryl group, an alkenyl group or an alkynyl group having 1 to 8 carbon atoms which may have a substituent.

<2> The curable composition according to <1>, which is an instant pressure sensitive adhesive.

<3> The curable composition according to <1> or <2>, in which the cured product of the curable composition has a glass transition temperature of 60° C. or lower.

<4> The curable composition according to any one of <1> to <3>, in which a tack value of the cured product of the curable composition in a probe tack test is from 0.1 N/cm² to 100 N/cm².

<5> The curable composition according to any one of <1> to <4>, in which an elongation rate of the cured product of the curable composition in a stress-strain curve is 350% or more.

<6> The curable composition according to any one of <1> to <5>, in which a 180° peeling pressure sensitive adhesive strength of a bonded body obtained by curing the curable composition to adhere a glass together with an easy-adhesive polyethylene terephthalate substrate, as measured in accordance with JIS Z 0237 (2009), is from 5 N/25 mm to 100 N/25 mm.

<7> The curable composition according to any one of <1> to <6>, in which a 180° peeling pressure sensitive adhesive strength of a bonded body obtained by curing the curable composition to adhere aluminum substrates together with each other, as measured in accordance with JIS Z 0237 (2009), is from 5 N/25 mm to 50 N/25 mm.

<8> The curable composition according to any one of <1> to <7>, in which each L¹ is independently —CH₂CH₂—, —CH(R²)CH₂— or —CH₂CH(R²)—, and R² is an alkyl group having 1 to 6 carbon atoms.

<9> The curable composition according to any one of <1> to <8>, in which p is an integer from 2 to 6.

<10> The curable composition according to any one of <1> to <9>, in which R¹ is a linear or branched alkyl group having 1 to 6 carbon atoms.

<11> The curable composition according to any one of <1> to <10>, in which:
an initial viscosity of the curable composition at 25° C. is 300 Pa·s or less; and
a storage modulus of the cured product of the curable composition becomes substantially constant in a range of from 1.0×10⁴ Pa to 1.0×10⁸ Pa, 60 minutes or less after a time of adding 1 μL of an acetone solution that contains 5% by volume of triethanolamine to 0.1 g of the curable composition under an environment of 25° C. and 60% RH.

<12> The curable composition according to any one of <1> to <11>, further including at least one compound selected from the group consisting of a tackifier, a plasticizer, a rubber toughener, an antioxidant, and a polymer.

<13> The curable composition according to any one of <1> to <12>, which is a curable composition for bonding a resin material.

### Advantageous Effects of Invention

According to the present invention, it is possible to provide a curable composition of which resulting cured product is excellent in pressure sensitive adhesiveness.

### BRIEF DESCRIPTION OF DRAWINGS

FIG. 1 shows the elongation rate of the cured product of the curable composition of each of Examples 2 to 4 and Comparative Example 1 in the stress-strain curve.

### DESCRIPTION OF EMBODIMENTS

The description of the constituent requirements described below may be made based on representative embodiments of the present invention, but the present invention is not limited to such embodiments. In the specification of the present application, the expression “(from) X to Y” is used to mean that the numerical values “X” and “Y” before and after “to” are included as the lower limit value and the upper limit value, respectively.

In the numerical ranges described stepwise in the present specification, the upper limit value or the lower limit value described in one numerical range may be replaced with the upper limit value or the lower limit value of another numerical range described stepwise. Moreover, in the numerical ranges described in the present specification, the upper limit values or the lower limit values of the numerical ranges may be replaced with the values indicated in the examples.

In the present invention, “% by mass” and “% by weight” are synonymous, and “parts by mass” and “parts by weight” are synonymous.

In addition, in the present invention, a combination of two or more preferred aspects is a more preferred aspect.

The details of the present invention will be described below.

(Curable Composition)

The curable composition of the present invention includes a 2-cyanoacrylate compound represented by Formula (1) below, in which a storage modulus of a cured product of the curable composition at 23° C. is from 1.0×10⁴ Pa to 1.0×10⁸ Pa.

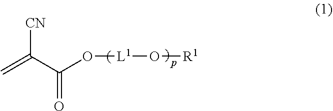

In Formula (1), each L¹ independently represents a linear or branched alkylene group having 2 to 6 carbon atoms which may have a substituent, p represents an integer from 2 to 8, and R¹ represents an linear or branched alkyl group, an aryl group, an alkenyl group or an alkynyl group having 1 to 8 carbon atoms which may have a substituent.

As a result of intensive studies by the present inventors, it was found that by adopting the aforementioned configuration, it is possible to provide a curable composition of which resulting cured product is excellent in pressure sensitive adhesiveness.

Although the mechanism of action of the excellent effect thereby is not clear, it is presumed as follows.

It is presumed that the 2-cyanoacrylate compound represented by Formula (1) having 2 to 8 alkyleneoxy structures is included and the storage modulus of a cured product of the curable composition at 23° C. falls within the range above, by which the resulting cured product has flexibility even after curing, has an appropriate pressure sensitive adhesive strength on a surface of the cured product, and is excellent in pressure sensitive adhesiveness.

Further, the curable composition of the present invention includes the 2-cyanoacrylate compound represented by Formula (1) having 2 to 8 alkyleneoxy structures and the storage modulus of a cured product of the curable composition at 23° C. falls within the range above, by which it is possible to configure a curable composition of which resulting cured product has a surface with an appropriate pressure sensitive adhesive strength, so that a bonded body can be peeled off from the resulting cured product and re-adhered thereto.

Furthermore, the curable composition of the present invention includes the 2-cyanoacrylate compound represented by Formula (1) having 2 to 8 alkyleneoxy structures and the storage modulus of a cured product of the curable composition at 23° C. falls within the range above, by which a rate of increase in pressure sensitive adhesive strength (curing rate) is excellent and the resulting cured product is excellent in pressure sensitive adhesiveness, so that the curable composition can be suitably used as an instant pressure sensitive adhesive.

### <Storage Modulus of Cured Product at 23° C.>

In the curable composition of the present invention, the storage modulus of a cured product of the curable composition at 23° C. is from 1.0×10⁴ Pa to 1.0×10⁸ Pa, and is preferably from 1.0×10⁴ Pa to 5.0×10⁷ Pa, more preferably from 1.0×10⁴ Pa to 1.0×10⁶ Pa, and particularly preferably from 5.0×10⁴ Pa to 5.0×10⁵ Pa, from the viewpoint of pressure sensitive adhesiveness of the resulting cured product.

It should be noted that the “cured product of the curable composition” in the present invention does not need to be a completely cured product as long as it has pressure sensitive adhesiveness as described above.

Further, the “curing” of the curable composition of the present invention means that anionic polymerization of the 2-cyanoacrylate compound represented by Formula (1) proceeds at least partially, and the viscosity increases compared to the initial viscosity of the composition.

### <Glass Transition Temperature of Cured Product>

In the curable composition of the present invention, the glass transition temperature (Tg) of a cured product of the curable composition is preferably 60° C. or lower, more preferably 35° C. or lower, further preferably from −20° C. to 35° C., and particularly preferably from −10° C. to 10° C., from the viewpoint of pressure sensitive adhesiveness of the resulting cured product.

The storage modulus and glass transition temperature (Tg) of a cured product of the curable composition of the present invention are as measured by the following methods.

After injecting the curable composition between jigs coated with triethanolamine for the following dynamic viscoelasticity measuring device, the storage modulus is measured under the conditions of a frequency of 1 Hz, a temperature of 25° C., and a thickness of 300 μm using a dynamic viscoelasticity measuring device (manufactured by Anton Paar, product name “MCR301”). Those for which it could be confirmed that no change in storage modulus was found are deemed to be cured products. Using the cured product, the storage modulus (G′), the loss modulus (G″), and the loss tangent (tan δ=G″/G′) due to shear are measured in a range of from −50° C. to 100° C. at a frequency of 1 Hz and a heating rate of 2° C./min.

In the present invention, “no change in storage modulus was found” means that the change rate in storage modulus per minute is 1% or less of the final storage modulus at 25° C.

Also, the glass transition temperature (Tg) of a cured product of the curable composition is determined using the peak temperature of the loss tangent (tan δ) as an evaluation index. A value at 23° C. is used for the storage modulus.

### <Tack Value in Probe Tack Test of Cured Product>

In the curable composition of the present invention, the tack value in a probe tack test of a cured product of the curable composition is preferably from 0.1 N/cm² to 100 N/cm², more preferably from 1 N/cm² to 100 N/cm², further preferably from 10 N/cm² to 100 N/cm², and particularly preferably from 50 N/cm² to 100 N/cm², from the viewpoint of pressure sensitive adhesiveness of the resulting cured product.

The tack value in a probe tack test of a cured product of the curable composition of the present invention is as measured by the following method.

A spacer with a thickness of 38 μm (release polyethylene terephthalate (PET) film (manufactured by Toyobo Film Solution Co., Ltd., product name “Purex A31”)) having a punched frame is placed on an easy-adhesive PET film with a thickness of 125 μm (manufactured by Toray Co., Ltd., product name “Lumirror 125U34”), and the adhesive composition was dropped within the spacer frame. On this, another release PET film coated with triethanolamine is covered and affixed thereto, and allowed to stand at room temperature (25° C., hereinafter the same) for 24 hours to be completely cured. After curing, the cured product is cut into a width of 15 mm and a length of 15 mm, and the release PET film is peeled off to obtain a test piece. For this test piece, the tack value (unit: N/cm²) is measured and calculated in accordance with ASTM D2979:2016 (partially compliant), Japanese Pharmacopoeia 6.12.(3.4.): the 17th revision “Probe Tack Test Method”, using a probe tack tester (manufactured by Tester Sangyo Co., Ltd., product name “TE-6002”).

### <Elongation Rate of Cured Product in Stress-Strain Curve>

In the curable composition of the present invention, the elongation rate of a cured product of the curable composition in a stress-strain curve is preferably 350% or more, more preferably 500% or more, further preferably 750% or more, and particularly preferably 900% or more, from the viewpoint of pressure sensitive adhesiveness and flexibility of the resulting cured product. Also, the upper limit value is preferably 10,000% or less.

The elongation rate of a cured product of the curable composition of the present invention in a stress-strain curve is as measured by the following method.

1 μL of triethanolamine is added to 1 g of the curable composition and stirred, and then poured into a frame of a silicone rubber with a thickness of 1 mm that is placed on a release PET film (manufactured by Toyobo Film Solution Co., Ltd., product name “Purex A31”). A release film is covered thereon, sandwiched between glass plates, and allowed to stand at room temperature for 24 hours to be completely cured. After curing, the frame and the release film were removed to prepare a cured product having a width of 5 mm, a length of 50 mm and a thickness of 1 mm. Using a tensile tester (manufactured by Toyo Seiki Seisakusho Co., Ltd., product name “Strograph V20-C”), the stress-strain curve of this cured product is measured, and the elongation rate is calculated.

### <180° Peeling Pressure Sensitive Adhesive Strength of Bonded Body>

The 180° peeling pressure sensitive adhesive strength of a bonded body obtained by curing the curable composition to adhere a glass together with an easy-adhesive polyethylene terephthalate (PET) substrate, as measured in accordance with JIS Z 0237 (2009), is as measured by the following method.

In the curable composition of the present invention, the 180° peeling pressure sensitive adhesive strength of a bonded body obtained by curing the curable composition to adhere a glass together with an easy-adhesive PET substrate, as measured in accordance with JIS Z 0237 (2009), is preferably from 5 N/25 mm to 100 N/25 mm, more preferably from 10 N/25 mm to 50 N/25 mm, further preferably from 10 N/25 mm to 35 N/25 mm, and particularly preferably from 10 N/25 mm to 25 N/25 mm, from the viewpoint of pressure sensitive adhesiveness and flexibility of the resulting cured product.

In addition, in the curable composition of the present invention, the 180° peeling pressure sensitive adhesive strength of a bonded body obtained by curing the curable composition to adhere aluminum substrates together with each other, as measured in accordance with JIS Z 0237 (2009), is preferably from 5 N/25 mm to 50 N/25 mm, more preferably from 5 N/25 mm to 35 N/25 mm, and particularly preferably from 5 N/25 mm to 25 N/25 mm, from the viewpoint of pressure sensitive adhesiveness and flexibility of the resulting cured product.

“Easy-adhesive” in the present invention means property of being easily adhered by the curable composition and being difficult to peel off after adhered.

### —Preparation of Bonded Body of Glass and Easy-Adhesive PET Substrate—

A spacer with a thickness of 38 μm (release PET film (manufactured by Toyobo Film Solution Co., Ltd., product name “Purex A31”)) having a punched frame with a width of 25 mm and a length of 150 mm is placed on a glass plate with a thickness of 1 mm (manufactured by AGC Fabritech Co., Ltd., product name “FL11AK”), and the resulting curable composition is dropped onto the glass within the spacer frame. On this, an easy-adhesive PET film with a thickness of 125 μm (manufactured by Toray Co., Ltd., product name “Lumirror 125U34”) coated with triethanolamine is covered and affixed thereto, and allowed to stand at room temperature for 24 hours to be completely cured. After curing, the spacer is removed to prepare a test piece having an adhesive layer with a thickness of 38 μm, a width of 25 mm, and a length of 150 mm, one side of which is the glass substrate and the other side of which is the easy-adhesive PET substrate.

### —Preparation of Bonded Body of Aluminum Substrates—

A spacer with a thickness of 38 μm (release PET film (manufactured by Toyobo Film Solution Co., Ltd., product name “Purex A31”)) having a punched frame with a width of 90 mm and a length of 150 mm is placed on an aluminum plate with a thickness of 0.1 mm (material specified in JIS A6061P), and the curable composition is dropped onto the aluminum plate within the spacer frame. On this, an aluminum plate with a thickness of 1 mm coated with triethanolamine is covered and affixed thereto, and allowed to stand at room temperature for 24 hours to be completely cured. After curing, the spacer is removed, and cut into a width of 25 mm to prepare a test piece having an adhesive layer with a thickness of 38 μm, a width of 25 mm, and a length of 150 mm, both sides of which are aluminum substrates.

### —Peeling Strength Measurement—

For the test piece prepared under the aforementioned conditions, the end of one side of the substrate (in the case of a bonded body of glass and an easy-adhesive PET substrate, the easy-adhesive PET substrate) is peeled in a peeling direction of 180° at a rate of 50 mm/min for the aluminum substrates or at a rate of 100 mm/min for the glass and easy-adhesive PET substrate, and the pressure sensitive adhesiveness (resistance) (unit: N/25 mm) to the adherend at that time is measured.

### <Viscosity of Curable Composition>

The viscosity of the curable composition of the present invention at 25° C. is preferably 300 Pa·s or less, more preferably 100 Pa·s or less, further preferably 50 Pa·s or less, and particularly preferably from 10 Pa·s to 50 Pa·s, from the viewpoint of applicability and pressure sensitive adhesiveness of the resulting cured product.

The viscosity of the curable composition of the present invention is measured using an E-type viscometer manufactured by Tokimec Co., Ltd. under the conditions of 25° C. and 100 rpm.

### <Curing Time>

In the curable composition of the present invention, from the viewpoint of applicability and pressure sensitive adhesiveness of the resulting cured product, the storage modulus of a cured product of the curable composition becomes substantially constant in a range of from 1.0×10⁴ Pa to 1.0×10⁸ Pa, preferably 60 minutes or less, more preferably 30 minutes or less, further preferably 20 minutes or less, and particularly preferably 10 minutes or less after a time of adding 1 μL of an acetone solution that contains 5% by volume of triethanolamine to 0.1 g of the curable composition under an environment of 25° C. and 60% RH.

Note that “the storage modulus of a cured product becomes substantially constant” means that the change rate in storage modulus per minute becomes 1% or less of the final storage modulus at 25° C.

The method for measuring the storage modulus of a cured product is as described above.

### <2-Cyanoacrylate Compound Represented by Formula (1)>

The curable composition of the present invention includes the 2-cyanoacrylate compound represented by Formula (1).

Examples of the substituent which each L¹ in Formula (1) may have include an aryl group, a halogen atom, an alkoxy group, an aryloxy group, a cyano group, an alkoxycarbonyl group, an aryloxycarbonyl group, an acyl group, and an acyloxy group.

Each L¹ in Formula (1) is independently preferably —CH₂CH₂—, —CH(R²)CH₂— or —CH₂CH(R²)—, and more preferably —CH(R²)CH₂— or —CH₂CH(R²)—, from the viewpoint of pressure sensitive adhesiveness of the resulting cured product.

R² represents an alkyl group having 1 to 6 carbon atoms, and preferably an alkyl group having 1 to 3 carbon atoms and more preferably a methyl group from the viewpoint of pressure sensitive adhesiveness of the resulting cured product.

Also, all R²'s in Formula (1) are preferably the same groups as each other.

Also, specific examples of L¹ in Formula (1) include an ethylene group, a 1,2-propylene group, a 1,3-propylene group, a 2,3-propylene group, a 1,2-butylene group, a 1,3-butylene group, a 1,4-butylene group, a 2,3-butylene group, a 2,4-butylene group, a 3,4-butylene group, a 1,2-pentylene group, a 1,3-pentylene group, a 1,4-pentylene group, a 2,3-pentylene group, a 2,4-pentylene group, a 2,5-pentylene group, a 3,4-pentylene group, a 3,5-pentylene group, and a 4,5-pentylene group.

Among them, an ethylene group, a 1,2-propylene group, a 1,3-propylene group, a 2,3-propylene group, a 1,2-butylene group, a 1,3-butylene group, a 1,4-butylene group, a 2,3-butylene group, a 2,4-butylene group or a 3,4-butylene group is preferable, a 1,2-propylene group, a 1,3-propylene group, a 2,3-propylene group or a 1,2-butylene group is more preferable, and a 1,2-propylene group or a 2,3-propylene group is particularly preferable, from the viewpoint of pressure sensitive adhesiveness of the resulting cured product,

The substituent which R¹ in Formula (1) may have is the same as the substituent which L¹ may have.

R¹ in Formula (1) is preferably a linear or branched alkyl group having 1 to 8 carbon atoms, an aryl group having 6 to 10 carbon atoms, a linear or branched alkenyl group having 2 to 8 carbon atoms, or an alkynyl group having 2 to 8 carbon atoms, more preferably a linear or branched alkyl group having 1 to 8 carbon atoms, more preferably a linear or branched alkyl group having 1 to 6 carbon atoms, and particularly preferably a linear or branched alkyl group having 1 to 4 carbon atoms, from the viewpoint of pressure sensitive adhesiveness of the resulting cured product. Moreover, the aforementioned alkyl group is preferably a linear alkyl group.

Specific examples of R¹ in Formula (1) include a methyl group, an ethyl group, an n-propyl group, an isopropyl group, an n-butyl group, a sec-butyl group, an isobutyl group, an n-hexyl group, an 2-ethylhexyl group, an 1-octyl group, an 2-octyl group, an allyl group, a phenyl group, and a benzyl group.

Among them, a methyl group, an ethyl group, an n-propyl group, an n-butyl group, an n-pentyl group, or an n-hexyl group is preferable, and a methyl group, an ethyl group, an n-propyl group, or n-butyl group is more preferable, from the viewpoint of pressure sensitive adhesiveness of the resulting cured product.

p in Formula (1) is preferably an integer from 2 to 6, more preferably an integer from 2 to 4, further preferably 3 or 4, and particularly preferably 3, from the viewpoint of pressure sensitive adhesiveness of the resulting cured product. Moreover, p is preferably 3 or more from the viewpoint of pressure sensitive adhesiveness and flexibility of the resulting cured product.
Specifically, preferred examples of the 2-cyanoacrylate compound represented by Formula (1) include an ester of 2-cyanoacrylate, such as 2-(2-methoxyethoxy)ethyl, 2-(2-ethoxyethoxy)ethyl, 2-(2-propyloxyethoxy)ethyl, 2-(2-butoxyethoxy)ethyl, 2-(2-pentyloxyethoxy)ethyl, 2-(2-hexyloxyethoxy)ethyl, 2-[2-(2-methoxyethoxy)ethoxy]ethyl, 2-[2-(2-ethoxyethoxy)ethoxy]ethyl, 2-[2-(2-propyloxyethoxy)ethoxy]ethyl, 2-[2-(2-butyloxyethoxy)ethoxy]ethyl, 2-[2-(2-pentyloxyethoxy)ethoxy]ethyl, 2-[2-(2-hexyloxyethoxy)ethoxy]ethyl, 1-(2-methoxy-1-methylethoxy)propyl-2-yl, 1-(2-methoxy-2-methylethoxy)propyl-2-yl, 2-(2-methoxy-2-methylethoxy)propyl-1-yl, 2-(2-methoxy-1-methylethoxy)propyl-2-yl, 1-(2-ethoxy-1-methylethoxy)propyl-2-yl, 1-(2-ethoxy-2-methylethoxy)propyl-2-yl, 2-(2-ethoxy-2-methylethoxy)propyl-1-yl, 2-(2-ethoxy-1-methylethoxy)propyl-2-yl, 1-(2-propoxy-1-methylethoxy)propyl-2-yl, 1-(2-propoxy-2-methylethoxy)propyl-2-yl, 2-(2-propoxy-2-methylethoxy)propyl-1-yl, 2-(2-propoxy-1-methylethoxy)propyl-2-yl, 1-(2-butoxy-1-methylethoxy)propyl-2-yl, 1-(2-butoxy-2-methylethoxy)propyl-2-yl, 2-(2-butoxy-2-methylethoxy)propyl-1-yl, 2-(2-butoxy-1-methylethoxy)propyl-2-yl, 1-(2-hexyloxy-1-methylethoxy)propyl-2-yl, 1-(2-hexyloxy-2-methylethoxy)propyl-2-yl, 2-(2-hexyloxy-2-methylethoxy)propyl-1-yl, 2-(2-hexyloxy-1-methylethoxy)propyl-2-yl,
1-[2-(2-methoxy-1-methylethoxy)-1-methylethoxy]propyl-2-yl, 1-[2-(2-methoxy-2-methylethoxy)-1-methylethoxy]propyl-2-yl, 1-[2-(2-methoxy-1-methylethoxy)-2-methylethoxy]propyl-2-yl, 1-[2-(2-methoxy-2-methylethoxy)-2-methylethoxy]propyl-2-yl, 2-[2-(2-methoxy-1-methylethoxy)-1-methylethoxy]propyl-1-yl, 2-[2-(2-methoxy-2-methylethoxy)-1-methylethoxy]propyl-1-yl, 2-[2-(2-methoxy-1-methylethoxy)-2-methylethoxy]propyl-1-yl, 2-[2-(2-methoxy-2-methylethoxy)-2-methylethoxy]propyl-1-yl, 1-[2-(2-ethoxy-1-methylethoxy)-1-methylethoxy]propyl-2-yl, 1-[2-(2-ethoxy-2-methylethoxy)-1-methylethoxy]propyl-2-yl, 1-[2-(2-ethoxy-1-methylethoxy)-2-methylethoxy]propyl-2-yl, 1-[2-(2-ethoxy-2-methylethoxy)-2-methylethoxy]propyl-2-yl, 2-[2-(2-ethoxy-1-methylethoxy)-1-methylethoxy]propyl-1-yl, 2-[2-(2-ethoxy-2-methylethoxy)-1-methylethoxy]propyl-1-yl, 2-[2-(2-ethoxy-1-methylethoxy)-2-methylethoxy]propyl-1-yl, 2-[2-(2-ethoxy-2-methylethoxy)-2-methylethoxy]propyl-1-yl, 1-[2-(2-propoxy-1-methylethoxy)-1-methylethoxy]propyl-2-yl, 1-[2-(2-propoxy-2-methylethoxy)-1-methylethoxy]propyl-2-yl, 1-[2-(2-propoxy-1-methylethoxy)-2-methylethoxy]propyl-2-yl, 1-[2-(2-propoxy-2-methylethoxy)-2-methylethoxy]propyl-2-yl, 2-[2-(2-propoxy-1-methylethoxy)-1-methylethoxy]propyl-1-yl, 2-[2-(2-propoxy-2-methylethoxy)-1-methylethoxy]propyl-1-yl, 2-[2-(2-propoxy-1-methylethoxy)-2-methylethoxy]propyl-1-yl, 2-[2-(2-propoxy-2-methylethoxy)-2-methylethoxy]propyl-1-yl,
1-[2-(2-butoxy-1-methylethoxy)-1-methylethoxy]propyl-2-yl, 1-[2-(2-butoxy-2-methylethoxy)-1-methylethoxy]propyl-2-yl, 1-[2-(2-butoxy-1-methylethoxy)-2-methylethoxy]propyl-2-yl, 1-[2-(2-butoxy-2-methylethoxy)-2-methylethoxy]propyl-2-yl, 2-[2-(2-butoxy-1-methylethoxy)-1-methylethoxy]propyl-1-yl, 2-[2-(2-butoxy-2-methylethoxy)-1-methylethoxy]propyl-1-yl, 2-[2-(2-butoxy-1-methylethoxy)-2-methylethoxy]propyl-1-yl, 2-[2-(2-butoxy-2-methylethoxy)-2-methylethoxy]propyl-1-yl, 1-[2-(2-hexyloxy-1-methylethoxy)-1-methylethoxy]propyl-2-yl, 1-[2-(2-hexyloxy-2-methylethoxy)-1-methylethoxy]propyl-2-yl, 1-[2-(2-hexyloxy-1-methylethoxy)-2-methylethoxy]propyl-2-yl, 1-[2-(2-hexyloxy-2-methylethoxy)-2-methylethoxy]propyl-2-yl, 2-[2-(2-hexyloxy-1-methylethoxy)-1-methylethoxy]propyl-1-yl, 2-[2-(2-hexyloxy-2-methylethoxy)-1-methylethoxy]propyl-1-yl, 2-[2-(2-hexyloxy-1-methylethoxy)-2-methylethoxy]propyl-1-yl, 2-[2-(2-hexyloxy-2-methylethoxy)-2-methylethoxy]propyl-1-yl, tetrapropylene glycol monomethyl ether, tetrapropylene glycol monoethyl ether, tetrapropylene glycol monopropyl ether, tetrapropylene glycol monobutyl ether, tetrapropylene glycol monopentyl ether, and tetrapropylene glycol monohexyl ether.

The 2-cyanoacrylate compound represented by Formula (1) used in the curable composition of the present invention may be used singly or in combination of two or more.

The content of the 2-cyanoacrylate compound represented by Formula (1) in the curable composition of the present invention is preferably from 40% by mass to 100% by mass, more preferably from 50% by mass to 99.5% by mass, further preferably from 60% by mass to 90% by mass, and particularly preferably from 70% by mass to 85% by mass with respect to the total mass of the curable composition, from the viewpoint of adhesiveness and curability.

### <Other Components>

The curable composition of the present invention may include components other than the 2-cyanoacrylate compound represented by Formula (1).

As other components, stabilizers, curing promoters, photopolymerization initiators, plasticizers, thickeners, particles, coloring agents, fragrances, solvents, strength improvers, rubber tougheners, antioxidants, polymers, or the like, which are conventionally used and blended in curable compositions containing 2-cyanoacrylate compounds can be blended according to the purpose in appropriate amounts within the range that does not impair the curability of the curable composition and the pressure sensitive adhesiveness of the resulting cured product.

The content of other components is preferably less than the content of the 2-cyanoacrylate compound, and is preferably 30% by mass or less, and more preferably 20% by mass or less, with respect to the total mass of the curable composition.

Among them, the curable composition of the present invention preferably further includes, as other component, at least one compound selected from the group consisting of a tackifier, a plasticizer, a rubber toughener, an antioxidant, and a polymer.

Examples of tackifiers include rosin derivatives such as a rosin ester, a gum rosin, a tall oil rosin, a hydrogenated rosin ester, a maleated rosin, and a disproportionated rosin ester; terpene phenol resins or terpene resins that are mainly formed of α-pinene, β-pinene, limonene, or the like; (hydrogenated)petroleum resins; coumarone-indene resins; hydrogenated aromatic copolymers; styrene resins; xylene resins; and (meth)acrylic polymers.

Examples of plasticizers include acetyl triethyl citrate, acetyl tributyl citrate, dimethyl adipate, diethyl adipate, dimethyl sebacate, dimethyl phthalate, diethyl phthalate, dibutyl phthalate, diisodecyl phthalate, dihexyl phthalate, diheptyl phthalate, dioctyl phthalate, bis(2-ethylhexyl)phthalate, diisononyl phthalate, diisotridecyl phthalate, dipentadecyl phthalate, dioctyl terephthalate, diisononyl isophthalate, decyl toluate, bis(2-ethylhexyl)camphorate, 2-ethylhexyl cyclohexyl carboxylate, diisobutyl fumarate, diisobutyl maleate, caproic acid triglyceride, 2-ethylhexyl benzoate, and dipropylene glycol dibenzoate. Among these, acetyl tributyl citrate, dimethyl adipate, dimethyl phthalate, 2-ethylhexyl benzoate, and dipropylene glycol dibenzoate are preferred because of their good compatibility with the 2-cyanoacrylate compound and high plasticization efficiency. These plasticizers may be used singly or in combination of two or more.

A known rubber toughener can be used as the rubber toughener, and preferred examples thereof include an ethylene acrylic acid elastomer. As the ethylene acrylic acid elastomer, for example, VAMAC elastomer manufactured by Dupont can be used.

The rubber toughener is preferably from 1.5% by mass to 20% by mass, more preferably from 5% by mass to 15% by mass, and particularly preferably from 8% by mass to 10% by mass, with respect to the total mass of the curable composition.

A known antioxidant can be used as the antioxidant, and preferred examples thereof include a hindered phenol compound.

The polymer may be a homopolymer or may be a copolymer, and a copolymer is preferred.

Specific examples of polymers include a polymer selected from the group consisting of poly(meth)acrylate, polyvinyl ether, natural rubber, polyisoprene, polybutadiene, polyisobutylene, polychloroprene, a butadiene acrylonitrile polymer, a thermoplastic elastomer, styrene-isoprene, a styrene-isoprene-styrene block copolymer, an ethylene-propylene-diene polymer, a styrene-butadiene polymer, a poly-α-olefin, a silicone, an ethylene-containing copolymer, ethylene vinyl acetate, and a combination thereof. Among them, the polymer is preferably poly(meth)acrylate or an ethylene vinyl acetate copolymer.

Examples of stabilizers include (1) anionic polymerization inhibitors, such as sulfur dioxide, aliphatic sulfonic acids (methanesulfonic acid etc.), aromatic sulfonic acids (p-toluenesulfonic acid etc.), boron trifluoride complexes (boron trifluoride methanol, boron trifluoride diethyl ether etc.), HBF₄, and trialkylborates and (2) radical polymerization inhibitors, such as hydroquinone, hydroquinone monomethyl ether, t-butylcatechol, catechol and pyrogallol. These stabilizers may be used singly or in combination of two or more.

Any curing promoter can be used as long as it promotes anionic polymerization of the 2-cyanoacrylate-based curable composition. Examples of curing promoters include polyether compounds, calixarenes, thiacalixarenes, pyrogallolallenes, and onium salts. These curing promoters may be used singly or in combination of two or more.

Examples of thickeners include polymethyl methacrylate, copolymers of methyl methacrylate and acrylic acid esters, copolymers of methyl methacrylate and other methacrylic acid esters, acrylic rubber, polyvinyl acetate, polyvinyl chloride, polyurethane resins, polyamide resins, polystyrene, cellulose esters, polyalkyl-2-cyanoacrylates, and ethylene-vinyl acetate copolymers. These thickeners may be used singly or in combination of two or more.

The particles that may be blended in the curable composition are those for adjusting the thickness of the adhesive layer when using the curable composition.

The average particle size of the particles is preferably from 10 μm to 200 μm, more preferably from 15 μm to 200 μm, and further preferably from 15 μm to 150 μm.

The material of the particles is not particularly limited as long as it is insoluble in the 2-cyanoacrylate compound used and does not cause deterioration such as polymerization. Examples thereof include thermoplastic resins such as polyethylene, polypropylene, polymethylpentene, acrylic resin, polyvinyl chloride, polytetrafluoroethylene, polyethylene terephthalate, polybutylene terephthalate, polysulfone, and polyphenylene oxide; crosslinked resins such as unsaturated polyester, divinylbenzene polymer, divinylbenzene-styrene copolymer, divinylbenzene-(meth)acrylic acid ester copolymer, and diallyl phthalate polymer; inorganic compounds such as spherical silica, glass beads, and glass fibers; silicone compounds; and organic-inorganic composite particles containing organic polymer skeletons and polysiloxane skeletons.

The content of the particles is not particularly limited, and is preferably from 0.1 parts by mass to 10 parts by mass, more preferably from 1 parts by mass to 5 parts by mass, and further preferably from 1 parts by mass to 3 parts by mass, when the content of the 2-cyanoacrylate compound is 100 parts by mass. When the content is in the range of from 0.1 parts by mass to 10 parts by mass, influence on the curing rate or the adhesive strength can be reduced.

The average particle size of the particles in the present invention is an average value on volume basis as measured by a laser diffraction particle size distribution analyzer.

The curable composition of the present invention can be used for various purposes without any particular limitation.

The cured product obtained by curing the curable composition of the present invention has its elastic modulus reduced and is softened by, for example, immersing the cured product in water at a temperature ranging from ambient temperature (15° C. to 25° C.) to approximately that of lukewarm water (30° C. to 45° C.), and as a result, can be peeled off. Therefore, for example, even if the curable composition of the present invention adheres to unintended places such as fingers and is cured, it can be easily removed with water. In addition, since peeling off is possible with water at a temperature ranging from ambient temperature to approximately that of lukewarm water, adhered optical components can be easily separated.

For example, when methoxyethoxyethoxyethyl cyanoacrylate is used as the 2-cyanoacrylate compound, the cured product obtained by curing the curable composition of the present invention is dissolved in water. Therefore, the adherend can be more easily separated.

Here, examples of temporary fixing for industrial use include temporary fixing of various electronic materials such as semiconductor wafers, optical materials, or the like, with various jigs such as polishing surface plates.

In addition, adherends to be adhered by the curable composition of the present invention are not particularly limited, and may be inorganic compounds, organic compounds, or inorganic-organic composites. Further, adherends may be made of the same material as each other or different materials from each other. In addition, the curable composition of the present invention can adhere solid objects of any shape.

### <Curing Method of Curable Composition>

The method for curing the curable composition of the present invention is not particularly limited as long as it enables polymerization curing by the 2-cyanoacrylate compound. The curable composition may be cured with water such as moisture or may be cured by light, and is preferably cured with water such as moisture.

When the curable composition of the present invention is cured by light, it can be cured by formulating a photopolymerization initiator, irradiating with ultraviolet rays or visible light using a high-pressure mercury lamp, a halogen lamp, a xenon lamp, an LED (light emitting diode) lamp, sunlight, or the like.

### <Use>

The curable composition of the present invention can be used for known curable compositions and known pressure sensitive adhesive compositions.

In addition, the curable composition of the present invention can be suitably used, for example, as an instant pressure sensitive adhesive. The “instant pressure sensitive adhesive” in the present invention means a curable composition of which the viscosity increases within 1 minute from the start of curing by water or light, and which allows at least one of two or more adherends adhered by the curable composition to be peeled off after the increase in viscosity becomes substantially constant; that is, after curing.

Since the curable composition of the present invention is moisture-curable and is excellent in storage stability, the curable composition can be used in a wide range of fields such as general use, industrial use and medical use.

Examples thereof include, but are not limited to, pressure sensitive adhesives, adhesives, coating agents (protective coating agents, etc.), printing inks (inkjet inks, etc.), photoresists, and sealants.

Specifically, the curable composition can be suitably used, for example, for sealing of electronic parts, for attachment of reel seats or threading guides in fishing rods, for fixing of wire materials such as coils, for fixing of magnetic heads to pedestals, for fillings used in dental treatment, for bonding or fixing between articles of the same kind as each other or different kinds from each other, such as bonding of artificial nails or decoration, or for coating.

Examples of the material of the adherend includes plastic, rubber, wood, metal, inorganic material, and paper.

Specific examples of plastic include polyvinyl alcohol, cellulose acetate resins such as triacetyl cellulose and diacetyl cellulose, acrylic resins, polyethylene terephthalate, polycarbonate, polyarylate, polyether sulfone, cyclic polyolefin resins derived from cyclic olefins such as norbornene as monomers, polyvinyl chloride, epoxy resins, and polyurethane resins.

Specific examples of rubber include natural rubber and styrene-butadiene rubber (SBR).

Specific examples of wood include natural wood and synthetic wood.

Specific examples of metal include steel plates, metal such as aluminum and chromium, and metal oxides such as zinc oxide (ZnO) and indium tin oxide (ITO).

Specific examples of inorganic material include glass, mortar, concrete, and stone.

Specific examples of paper include fine paper, coated paper, art paper, imitation paper, thin paper, thick paper, and various synthetic papers.

Among them, the curable composition of the present invention can be particularly suitably used as a curable composition for bonding a resin substrate.

### EXAMPLES

The present invention will be specifically described below based on examples. It should be noted that the present invention is not limited to these examples. Further, hereinafter, “parts” and “%” mean “parts by mass” and “% by mass”, respectively, unless otherwise specified.

### Examples 1 to 4 and Comparative Example 1

The 2-cyanoacrylate compounds described in Table 1 or Table 2 were used for curable compositions.

Using the resulting curable compositions, the following measurement of physical property values and evaluation were carried out. The evaluation results are shown in Table 1 or Table 2.

### <Measurement of Glass Transition Temperature and Storage Modulus of Cured Product>

The glass transition temperature (Tg) and the storage modulus of the cured product of the curable composition were measured by the following methods.

After injecting the curable composition between jigs coated with triethanolamine for the following dynamic viscoelasticity measuring device, the storage modulus was measured under the conditions of a frequency of 1 Hz, a temperature of 25° C., and a thickness of 300 μm using a dynamic viscoelasticity measuring device (manufactured by Anton Paar, product name “MCR301”). Those for which it could be confirmed that no change in storage modulus was found were deemed to be cured products. Using the cured product, the storage modulus (G′), the loss modulus (G″), and the loss tangent (tan δ=G″/G′) due to shear were measured in a range of from −50° C. to 100° C. at a frequency of 1 Hz and a heating rate of 2° C./min.

The glass transition temperature (Tg) was determined using the peak temperature of the loss tangent (tan δ) as an evaluation index. A value at 23° C. was used for the storage modulus.

### <Measurement of Tack Value of Cured Product in Probe Tack Test>

A spacer with a thickness of 38 μm (release polyethylene terephthalate (PET) film (manufactured by Toyobo Film Solution Co., Ltd., product name “Purex A31”)) having a punched frame was placed on an easy-adhesive PET film with a thickness of 125 μm (manufactured by Toray Co., Ltd., product name “Lumirror 125U34”), and the adhesive composition was dropped within the spacer frame. On this, another release PET film coated with triethanolamine was covered and affixed thereto, and allowed to stand at room temperature (25° C., hereinafter the same) for 24 hours to be completely cured. After curing, the cured product was cut into a width of 15 mm and a length of 15 mm, and the release PET film was peeled off to obtain a test piece. For this test piece, the tack value (unit: N/cm²) was measured and calculated in accordance with ASTM D2979:2016 (partially compliant), Japanese Pharmacopoeia 6.12.(3.4.): the 17th revision “Probe Tack Test Method”, using a probe tack tester (manufactured by Tester Sangyo Co., Ltd., product name “TE-6002”).

### <Measurement of Elongation Rate of Cured Product in Stress-Strain Curve>

1 μL of triethanolamine was added to 1 g of the curable composition and stirred, and then poured into a frame of a silicone rubber with a thickness of 1 mm that was placed on a release PET film (manufactured by Toyobo Film Solution Co., Ltd., product name “Purex A31”). A release film was covered thereon, sandwiched between glass plates, and allowed to stand at room temperature for 24 hours to be completely cured. After curing, the frame and the release film were removed to prepare a cured product having a width of 5 mm, a length of 50 mm and a thickness of 1 mm. Using a tensile tester (manufactured by Toyo Seiki Seisakusho Co., Ltd., product name “Strograph V20-C”), the stress-strain curve of this cured product was measured, and the elongation rate was calculated.

### <Viscosity of Curable Composition>

Using an E-type viscometer manufactured by Tokimec Co., Ltd., the measurement was performed under the conditions of 25° C. and 100 rpm.

### <180° Peeling Strength Test of Bonded Body>

### —Preparation of Bonded Body of Glass and Easy-Adhesive PET Substrate—

A spacer with a thickness of 38 μm (release PET film (manufactured by Toyobo Film Solution Co., Ltd., product name “Purex A31”)) having a punched frame with a width of 25 mm and a length of 150 mm was placed on a glass plate with a thickness of 1 mm (manufactured by AGC Fabritech Co., Ltd., product name “FL11AK”), and the resulting curable composition was dropped onto the glass within the spacer frame. On this, an easy-adhesive PET film with a thickness of 125 μm (manufactured by Toray Co., Ltd., product name “Lumirror 125U34”) coated with triethanolamine was covered and affixed thereto, and allowed to stand at room temperature for 24 hours to be completely cured. After curing, the spacer was removed to prepare a test piece having an adhesive layer with a thickness of 38 μm, a width of 25 mm, and a length of 150 mm, one side of which was the glass substrate and the other side of which was the easy-adhesive PET substrate.

### —Preparation of Bonded Body of Aluminum Substrates—

A spacer with a thickness of 38 μm (release PET film (manufactured by Toyobo Film Solution Co., Ltd., product name “Purex A31”)) having a punched frame with a width of 90 mm and a length of 150 mm was placed on an aluminum plate with a thickness of 0.1 mm (material specified in JIS A6061P), and the curable composition was dropped onto the aluminum plate within the spacer frame. On this, an aluminum plate with a thickness of 1 mm coated with triethanolamine was covered and affixed thereto, and allowed to stand at room temperature for 24 hours to be completely cured. After curing, the spacer was removed, and cut into a width of 25 mm to prepare a test piece having an adhesive layer with a thickness of 38 μm, a width of 25 mm, and a length of 150 mm, both sides of which were aluminum substrates.

### —Peeling Strength Measurement—

For the test piece prepared under the aforementioned conditions, the end of one side of the substrate (in the case of a bonded body of glass and an easy-adhesive PET substrate, the easy-adhesive PET substrate) was peeled in a peeling direction of 180° at a rate of 50 mm/min for the aluminum substrates or at a rate of 100 mm/min for the glass and easy-adhesive PET substrate, and the pressure sensitive adhesiveness (resistance) (unit: N/25 mm) to the adherend at that time was measured.

TABLE 1

| | | | | Pressure sensitive | | | | |
|---|---|---|---|---|---|---|---|---|
| | | | | adhesive strength | | | | Glass |
| | | | | (Peeling strength | | Elon- | Storage | transition |
| | | | Tack | (N/25 mm)) | | gation | modulus | temper- |
| | | | value | Glass/easy- | | rate in | of cured | ature |
| | | | Probe | adhesive | | stress- | product at | of cured |
| | 2-Cyanoacrylate compound | | Tack | PET | | strain | 23° C. | product |
| | Name | Structural formula | (N/cm²) | substrate | Al/Al | curve (%) | (Pa) | (° C.) |
| Example 1 | Methoxypro- poxypropoxy propyl cyanoacrylate (isomer mixture) | 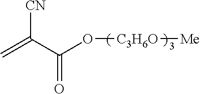 | 74.14 | 17.81 | 7.76 | — | 8.09 × 10⁴ | 6 |
| Example 2 | Methoxy- ethoxyethoxy ethyl cyanoacrylate | 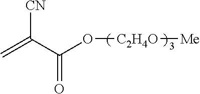 | 57.81 | 22.65 | 22.19 | >986 | 2.56 × 10⁵ | 8 |
| Example 3 | Methoxy- ethoxyethyl cyanoacrylate | 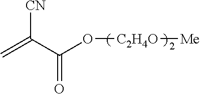 | 0.24 | 41.71 | 31.92 | 645 | 1.08 × 10⁷ | 36 |
| Example 4 | Buthoxy- ethoxyethyl cyanoacrylate | 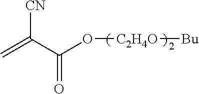 | 0.14 | 39.43 | 20.53 | 913 | 1.32 × 10⁷ | 55 |
| Comparative Example 1 | Ethoxyethyl cyanoacrylate | 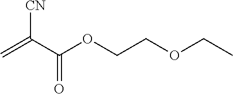 | ≤0.05 | 1.84 | 4.41 | 320 | 6.21 × 10⁸ | 68 |

TABLE 2

| | | | | Time until storage modulus becomes |
|---|---|---|---|---|
| | | | | constant after time of adding 1 μL of |
| | | | Initial | acetone solution that contains 5% by |
| | 2-Cyanoacrylate compound | | viscosity | volume of ethanolamine as curing promoter to |
| | Name | Structural formula | (Pa · s) | 0.1 g of curable composition (min) |
| Example 1 | Methoxypro- poxypropoxy propyl cyanoacrylate (isomer mixture) | 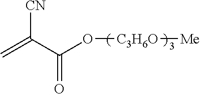 | 13.59 | 15 |
| Example 2 | Methoxy- ethoxyethoxy ethyl cyanoacrylate | 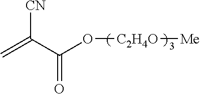 | 13.53 | 11 |
| Example 3 | Methoxy- ethoxyethyl cyanoacrylate | 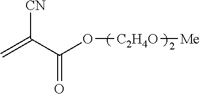 | 8.21 | 12 |
| Example 4 | Buthoxy- ethoxyethyl cyanoacrylate | 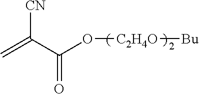 | 9.97 | 15 |
| Comparative Example 1 | Ethoxyethyl cyanoacrylate | 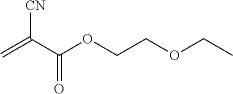 | 6.73 | 20 |

In the chemical structural formulae in Table 1 and Table 2, Me represents a methyl group, Bu represents an n-butyl group, C₃H₆O is a group of mixture of —CH(CH₃)CH₂O— and —CH₂CH(CH₃)O—. The 2-cyanoacrylate compound used in Example 1 is a mixture of regioisomers and optical isomers.

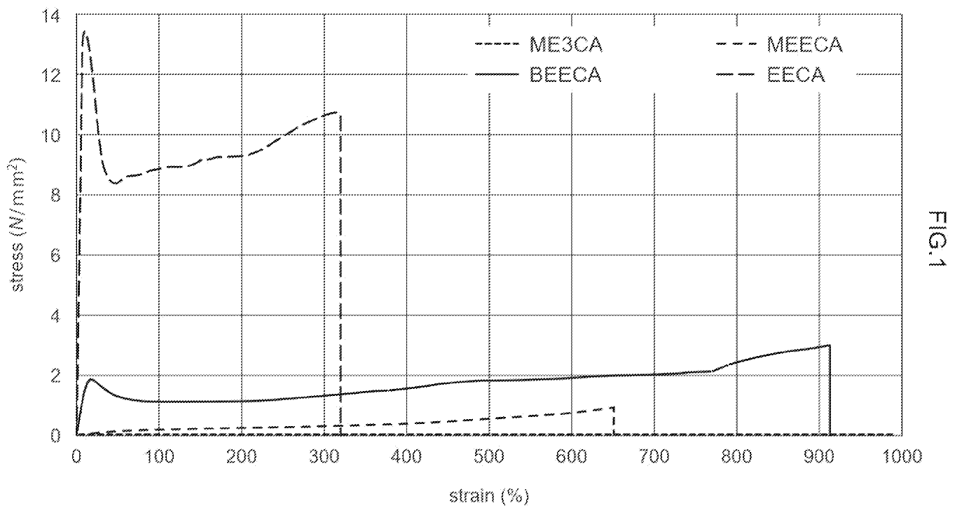

In addition, FIG. 1 shows the elongation rate of the cured product of the curable composition of each of Examples 2 to 4 and Comparative Example 1 in the stress-strain curve.

The vertical axis in FIG. 1 represents stress (unit: N/mm²), and the horizontal axis represents strain (strain=elongation rate, unit: %).

In addition, the details of the abbreviations in FIG. 1 are as follows.
ME3CA: Methoxyethoxyethoxyethyl cyanoacrylate (Example 2)
MEECA: Methoxyethoxyethyl cyanoacrylate (Example 3)
BEECA: Butoxyethoxyethyl cyanoacrylate (Example 4)
EECA: Ethoxyethyl cyanoacrylate (Comparative Example 1)

As shown in Table 1, the curable compositions of Examples 1 to 4 were superior to the curable composition of Comparative Example 1 in terms of pressure sensitive adhesiveness of the resulting cured product.

In addition, as shown in Table 1 and Table 2, the curable compositions of Examples 1 to 4 were excellent in curing rate, and the resulting cured products were also excellent in flexibility.

The disclosure of Japanese Patent Application No. 2020-173323, filed Oct. 14, 2020, is incorporated herein by reference in its entirety.

All publications, patent applications and technical standards mentioned in this specification are herein incorporated by reference to the same extent as if each individual publication, patent application or technical standard was specifically and individually indicated to be incorporated by reference.

### INDUSTRIAL APPLICABILITY

The curable composition of the present invention includes the 2-cyanoacrylate compound represented by Formula (1), and can be used in a wide range of products or technical fields such as general household use, educational materials, building materials, and medical fields, as well as various industrial fields. In particular, the curable composition is useful for bonding a resin substrate.

In addition, the curable composition of the present invention can be suitably used for bonding not only between adherends of the same kind as each other but also between adherends of different kinds from each other (for example, between metal and resin).

Furthermore, the cured product in the present invention can be suitably used as an instant pressure sensitive adhesive.

1. A curable composition, comprising a 2-cyanoacrylate compound represented by Formula (1) below,
wherein a storage modulus of a cured product of the curable composition at 23° C. is from 1.0×10⁴ Pa to 1.0×10⁸ Pa: 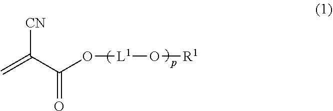
wherein, in Formula (1), each L¹ independently represents a linear or branched alkylene group having 2 to 6 carbon atoms which may have a substituent, p represents an integer from 2 to 8, and R¹ represents an linear or branched alkyl group, an aryl group, an alkenyl group or an alkynyl group having 1 to 8 carbon atoms which may have a substituent.

2. The curable composition according to claim 1, which is an instant pressure sensitive adhesive.

3. The curable composition according to claim 1, wherein the cured product of the curable composition has a glass transition temperature of 60° C. or lower.

4. The curable composition according to claim 1, wherein a tack value of the cured product of the curable composition in a probe tack test is from 0.1 N/cm² to 100 N/cm².

5. The curable composition according to claim 1, wherein an elongation rate of the cured product of the curable composition in a stress-strain curve is 350% or more.

6. The curable composition according to claim 1, wherein a 180° peeling pressure sensitive adhesive strength of a bonded body obtained by curing the curable composition to adhere a glass together with an easy-adhesive polyethylene terephthalate substrate, as measured in accordance with JIS Z 0237 (2009), is from 5 N/25 mm to 100 N/25 mm.

7. The curable composition according to claim 1, wherein a 180° peeling pressure sensitive adhesive strength of a bonded body obtained by curing the curable composition to adhere aluminum substrates together with each other, as measured in accordance with JIS Z 0237 (2009), is from 5 N/25 mm to 50 N/25 mm.

8. The curable composition according to claim 1, wherein each L¹ is independently —CH₂CH₂—, —CH(R²)CH₂— or —CH₂CH(R²)—, and R² is an alkyl group having 1 to 6 carbon atoms.

9. The curable composition according to claim 1, wherein p is an integer from 2 to 6.

10. The curable composition according to claim 1, wherein R¹ is a linear or branched alkyl group having 1 to 6 carbon atoms.

11. The curable composition according to claim 1, wherein:
an initial viscosity of the curable composition at 25° C. is 300 Pa·s or less; and
a storage modulus of the cured product of the curable composition becomes substantially constant in a range of from 1.0×10⁴ Pa to 1.0×10⁸ Pa, 60 minutes or less after a time of adding 1 μL of an acetone solution that contains 5% by volume of triethanolamine to 0.1 g of the curable composition under an environment of 25° C. and 60% RH.

12. The curable composition according to claim 1, further comprising at least one compound selected from the group consisting of a tackifier, a plasticizer, a rubber toughener, an antioxidant, and a polymer.

13. The curable composition according to claim 1 any one of claims 1 to 12, which is a curable composition for bonding a resin material.
